(19) United States
(12) Patent Application Publication
(10) Pub. No.: US 2022/0368624 A1
(43) Pub. Date: Nov. 17, 2022

(54) MANAGING CHANGES TO INTERDEPENDENT NETWORK ELEMENTS

(71) Applicants: AT&T Intellectual Property I, L.P., Atlanta, GA (US); AT&T Global Network Services (UK) B.V., The Hague (NL)

(72) Inventors: Stephen Wolyn, Tinton Falls, NJ (US); Gur Rotkop, Leamington Spa (GB); Linda Clayton, Tinton Falls, NJ (US); Kun-Tsun Chen, Holmdel, NJ (US); Qun Luo, Marlboro, NJ (US); Rakesh Sinha, Edison, NJ (US); Carlos Eduardo De Andrade, Gainesville, FL (US); Gilbert Figueroa, Piscataway Township, NJ (US); Prasanna Ramachandran, Morganville, NJ (US)

(21) Appl. No.: 17/322,036

(22) Filed: May 17, 2021

(51) Int. Cl. H04L 12/707; H04L 12/721; H04L 12/705; H04L 12/715

(52) U.S. Cl. CPC H04L 45/22; H04L 45/124; H04L 45/18; H04L 45/64

(57) ABSTRACT

The technologies described herein are generally directed to modeling radio wave propagation in a fifth generation (5G) network or other next generation networks. For example, a method described herein can include, facilitating receiving a disabling request for a first time period and applicable to a first service element in a first service path of first service elements to provide a service. The method can further include identifying, by the configuration equipment, and scheduled change data, a second service element from a combined group of the first and second service elements of a second service path for the provision of the service. Further, based on a first determination that the second service element is to be disabled during the first time period, facilitating disabling the first service element during a second time period where the second service element is not disabled.

### TECHNICAL FIELD

The subject application is related to implementation of network systems or other next generation wireless communication systems, and, for example, different approaches to changing change activities for network system elements.

### BACKGROUND

As network implementation have continued to increase in complexity and diversity in component types, problems can occur when components are required to be taken out of service for updates, maintenance, and other circumstances. These problems can be compounded when networks have components with complex interdependencies, redundant sets of components, and management responsibility for different components lies with different organizations within an enterprise.

### BRIEF DESCRIPTION OF THE DRAWINGS

The technology described herein is illustrated by way of example and not limited in the accompanying figures in which like reference numerals indicate similar elements and in which:

FIG. 1 is an architecture diagram of an example system that can facilitate managing conflict during changes to interdependent network elements, in accordance with one or more embodiments.

FIG. 2 is a diagram of a non-limiting example system that can facilitate managing conflict during changes to interdependent network elements, in accordance with one or more embodiments.

FIG. 3 is a diagram of a non-limiting example system that can facilitate managing conflicts during changes to interdependent network elements, in accordance with one or more embodiments.

FIG. 4 is a diagram of a non-limiting example system that can facilitate managing changes to interdependent network elements, in accordance with one or more embodiments.

FIG. 5 is a diagram of a non-limiting example of timeline that depicts managing changes to interdependent network elements, in accordance with one or more embodiments.

FIG. 6 illustrates an example method that can facilitate managing changes to interdependent network elements, in accordance with one or more embodiments.

FIG. 7 is a diagram of a non-limiting example system that can facilitate managing changes to interdependent network elements, in accordance with one or more embodiments.

FIG. 8 depicts an example non-transitory machine-readable medium that can include executable instructions that, when executed by a processor of a system, can facilitate managing changes to interdependent network elements, in accordance with one or more embodiments described above.

FIG. 9 illustrates an example block diagram of an example mobile handset operable to engage in a system architecture that can facilitate processes described herein, in accordance with one or more embodiments.

FIG. 10 illustrates an example block diagram of an example computer operable to engage in a system architecture that can facilitate processes described herein, in accordance with one or more embodiments.

### DETAILED DESCRIPTION

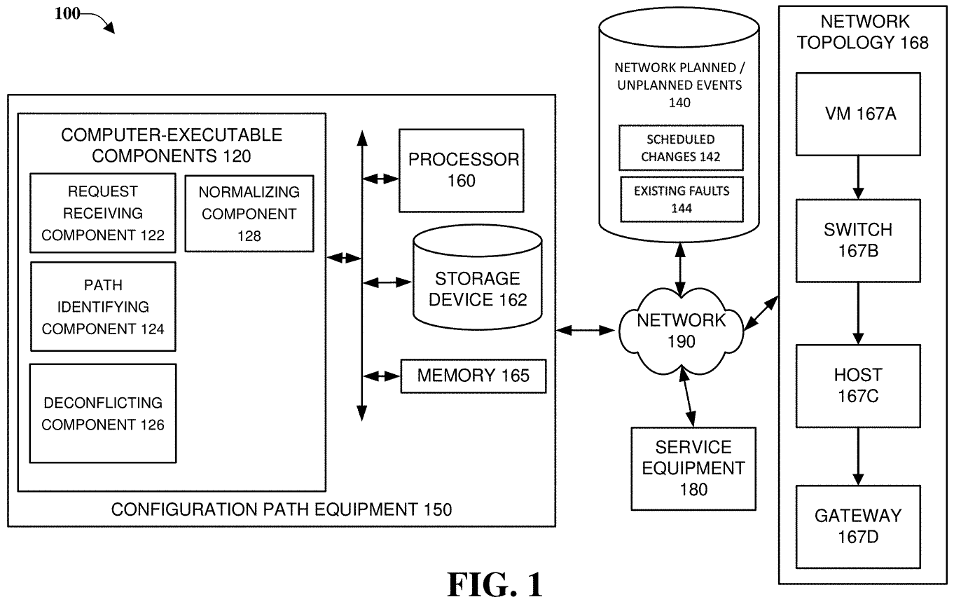

Aspects of the subject disclosure will now be described more fully hereinafter with reference to the accompanying drawings in which example components, graphs and selected operations are shown. In the following description, for purposes of explanation, numerous specific details are set forth in order to provide a thorough understanding of the various embodiments. For example, some embodiments described can facilitate managing conflict during changes to interdependent network elements. Different examples that describe these aspects are included with the description of FIGS. 1-10 below. It should be noted that the subject disclosure may be embodied in many different forms and should not be construed as limited to this example or other examples set forth herein.

It is noted that the subject disclosure may be embodied in many different forms and should not be construed as limited to this example or other examples set forth herein. The above-described background relating to network hardware is merely intended to provide a contextual overview of some current issues, and is not intended to be exhaustive. Other contextual information may become further apparent upon review of the following detailed description. managing changes to interdependent network elements.

FIG. 1 is an architecture diagram of an example system 100 that can facilitate managing conflict during changes to interdependent network elements, in accordance with one or more embodiments. For purposes of brevity, description of like elements and/or processes employed in other embodiments is omitted.

One or more embodiments can address problems such as those described in the Background section above with inventive concepts that include different approaches to managing conflict during changes to interconnected network hardware. In some embodiments, the specific manner in which a software change can be implemented without conflict on a network component may depend upon specific characteristics of that network component, such as its vendor or version. As another example, it may be desirable to avoid scheduling constraints, which may prevent certain software changes from being implemented at the same time. Further, it may be desirable to minimize or eliminate the impact of rolling out the software change on the network traffic. As another example, it may be advantageous to incrementally rollout a software change across the network to determine the impact that software change may have on network performance.

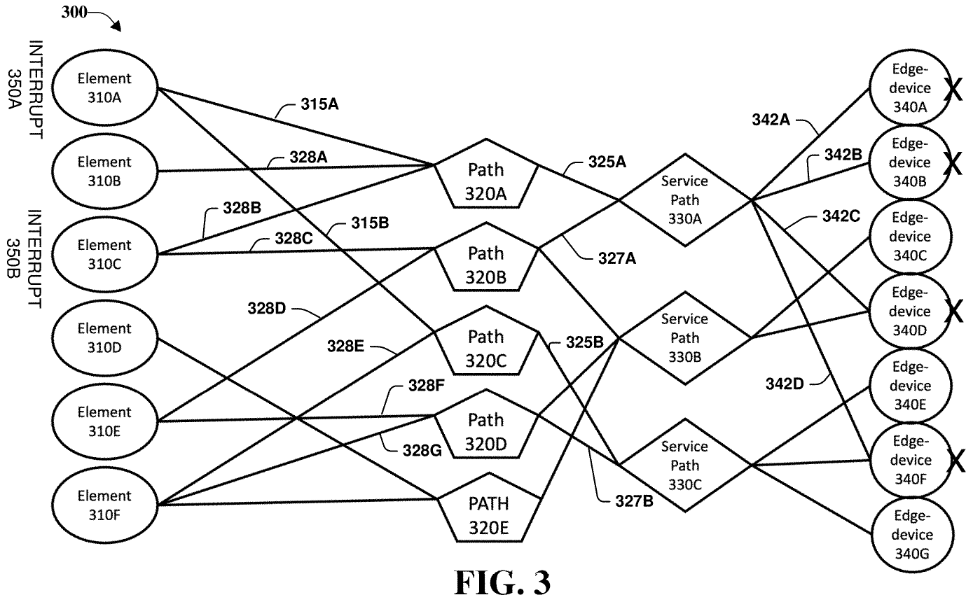

As depicted, system 100 can include configuration equipment 150 communicatively coupled to service equipment 180 and network topology 168 via network 190. In one or more embodiments, configuration equipment 150 can include computer executable components 120, processor 160, storage device 162, and memory 165. Network topology 168 can include linked service elements 167A-D, e.g., virtual machine (VM) 167A, switch 167B, host 167C, and gateway 167D. System 100 can further include a reference for network planned/unplanned events 140 including, but not limited to, scheduled changes 142 and existing faults 144. As described with FIGS. 3-5 below, when changes to service elements, one or more embodiments can analyze scheduled changes 142 and existing faults 144, e.g., service elements that are currently out of service.

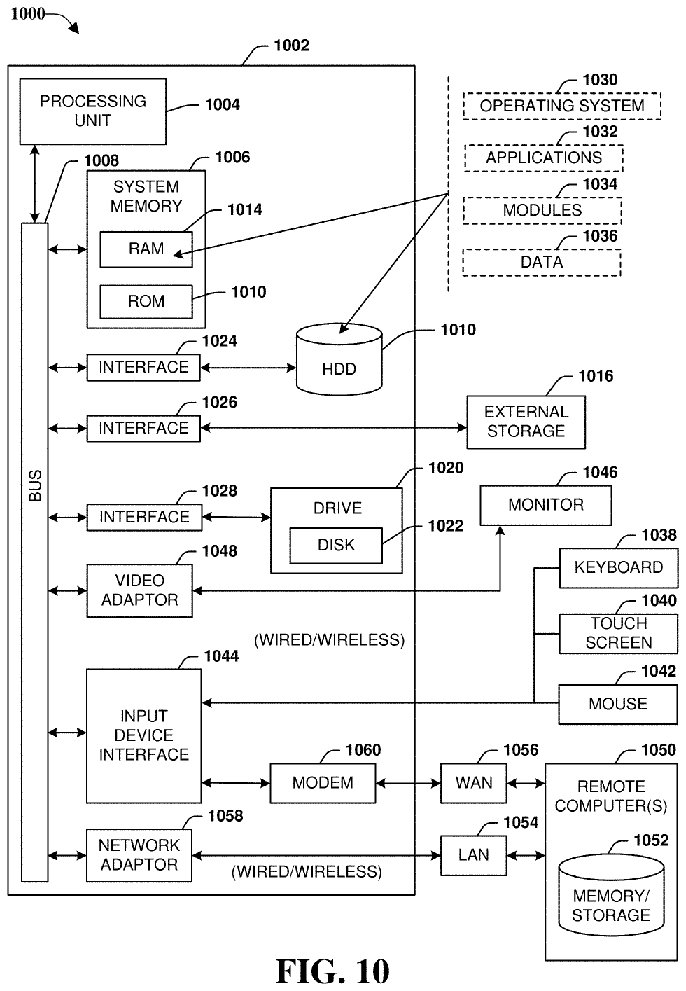

Computer executable components 120 can include request receiving component 122, path identifying component 124, deconflicting component 126, normalizing component 128, and other components described or suggested by different embodiments described herein that can improve the operation of system 100. It is noted that these components, as well as aspects of the embodiments of the subject disclosure depicted in this figure and various figures disclosed herein, are for illustration only, and as such, the architecture of such embodiments are not limited to the systems, devices, and/or components depicted therein. For example, in some embodiments, configuration equipment 150 can further comprise various computer and/or computing-based elements described herein with reference to operating environment 1000 and FIG. 10.

According to multiple embodiments, network 190 can comprise, but are not limited to, wired and wireless networks, including, but not limited to, a cellular network, a wide area network (WAN) (e.g., the Internet) or a local area network (LAN). For example, system 100 can communicate with one or more external systems, sources, and/or devices, for instance, computing devices (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

According to multiple embodiments, storage device 162 can include, but is not limited to, RAM, ROM, EEPROM, flash memory or other memory technology, solid state drive (SSD) or other solid-state storage technology, Compact Disk Read Only Memory (CD ROM), digital video disk (DVD), blu-ray disk, or other optical disk storage, magnetic cassettes, magnetic tape, magnetic disk storage or other magnetic storage devices, or any other medium which can be used to store the desired information and which can be accessed by the computer.

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a system on a chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

According to multiple embodiments, configuration equipment 150 can include memory 165 that can store one or more computer and/or machine readable, writable, and/or executable components and/or instructions 120 that, when respectively executed by processor 160, can facilitate performance of operations defined by the executable component(s) and/or instruction(s).

Generally, applications (e.g., computer executable components 120) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

It is noted that the embodiments of the subject disclosure depicted in various figures disclosed herein are for illustration only, and as such, the architecture of such embodiments are not limited to the systems, devices, and/or components depicted therein. For example, in some embodiments, configuration equipment 150 can further comprise various computer and/or computing-based elements described herein with reference to operating environment 1000 and FIG. 10. In one or more embodiments, such computer and/or computing-based elements can be used in connection with implementing one or more of the systems, devices, components, and/or computer-implemented operations shown and described in connection with FIG. 1 or other figures disclosed herein.

For example, in one or more embodiments, computer executable components 120 can be used in connection with implementing one or more of the systems, devices, components, and/or computer-implemented operations shown and described in connection with FIG. 1 or other figures disclosed herein. For example, in one or more embodiments, computer executable components 120 can include instructions that, when executed by processor 160, can facilitate performance of operations defining request receiving component 122. As discussed with examples of one or more embodiments below, request receiving component 122 can, in accordance with one or more embodiments, receive a disabling request for a first time period and applicable to a first service element of first service elements. In some embodiments described herein, the first service element can be comprised in a first service path of first service elements, and wherein the first service path is a logical path of service elements that provide functions directed to providing a service.

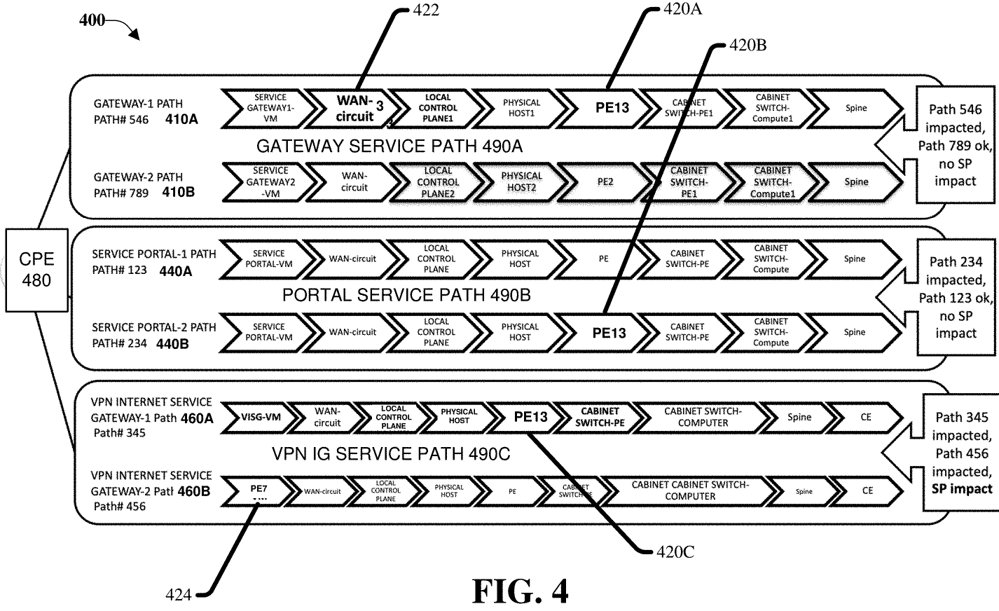

Example services and service elements are discussed further with FIG. 4 below, with services including, but not being limited to, a portal service that can provide interface functions for applications to access a network, a gateway service that links to another network, a virtual private network (VPN), and Internet gateway (IG) service for securely connecting to other networks via Internet resources. One having skill in the relevant art(s), given the description herein, will appreciate other services that can benefit from implementation using approaches described herein. As used with some examples herein, service elements can include different resources (e.g., computing resources) that can perform functions in furtherance of the services described above.

In another example, in one or more embodiments, computer executable components 120 can include instructions that, when executed by processor 160, can facilitate performance of operations defining path identifying component 124. As discussed with FIGS. 3-5 below, path identifying component 124 can, in accordance with one or more embodiments, identify a second service element from a combined group of the first service elements and second service elements comprised in a second service path for the provision of the service. As described further with FIG. 4 below, an example second service path can be a different collection of linked service elements that can also be used to perform the service described above.

In additional embodiments, computer executable components 120 can include instructions that, when executed by processor 160, can facilitate performance of operations defining deconflicting component 126. As discussed with FIGS. 3-5 below, deconflicting component 126 can, in accordance with one or more embodiments, based on a first determination that the second service element is to be disabled during the first time period, facilitate disabling the first service element during a second time period where the second service element is not disabled.

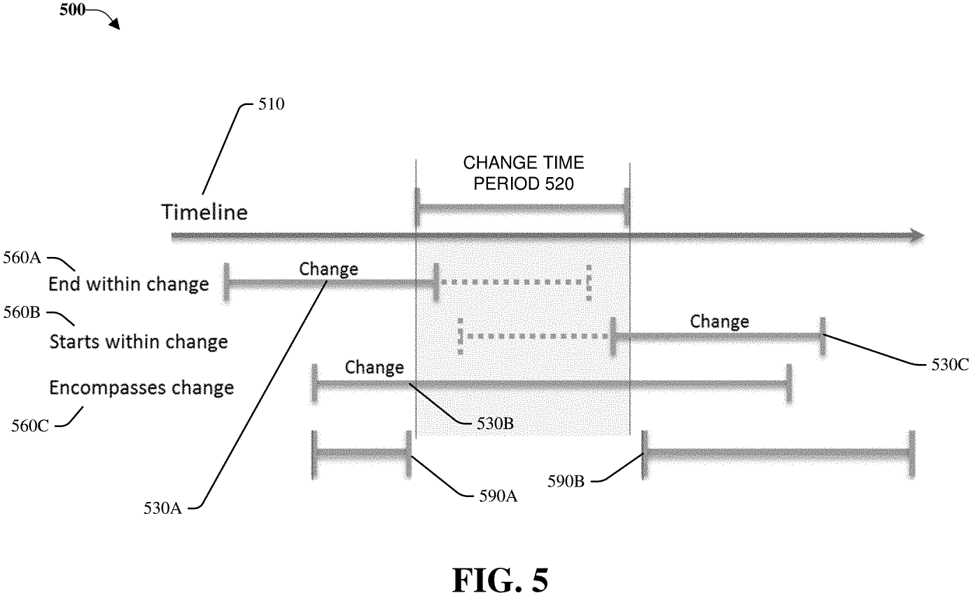

In another example, in one or more embodiments, computer executable components 120 can include instructions that, when executed by processor 160, can facilitate performance of operations defining normalizing component 128. As discussed with FIG. 5 below, in one or more embodiments, normalizing component 128 can normalize descriptive terms for the path information from the first network equipment, the second network equipment, and scheduled change data, resulting in normalized terms. Based on the normalized terms, deconflicting component 126 can, in some circumstances, identify the second service element.

One or more embodiments can implement software and hardware changes across a subset of managed network components. These changes can include, but are not limited to, software patches, software updates, configuration changes, re-routing traffic, migrating customers, installation/uninstallation of software, adding additional equipment, removing equipment, and upgrading hardware and software components of network equipment that can collectively provide services. Example service resources can include, but are not limited to, specialized networking equipment executing on dedicated hardware (e.g., routers, firewalls, and gateways) and virtualized network components, such as VNFs (virtual network functions) and virtual machines (VMs) that can be implemented or run on general purpose hardware within a cloud infrastructure.

The above-described background relating to network hardware is merely intended to provide a contextual overview of some current issues and is not intended to be exhaustive. Other contextual information may become further apparent upon review of the following detailed description.

It should be noted that, in one or more embodiments, system 100 and other embodiments described herein can employ hardware and/or software to solve problems that are highly technical in nature, including improving the managing of interdependent network elements. One having skill in the relevant art(s), given the disclosure herein, would appreciate that the technical problems that can be solved by one or more embodiments described herein are not abstract and cannot be performed as a set of mental acts by a human, e.g., in some circumstances network changes can be requested or required to be scheduled across multiple groups, where each group may have a set of complex constraints.

In an example implementation, updates can in some circumstances be requested or required across multiple groups that work on a common network elements, e.g., eNBs. As would be appreciated by one having skill in the relevant art(s), given the embodiments described herein, with some types of eNB, changes can be beneficially performed sequentially, not simultaneously, e.g., scheduled maintenance across a large set of eNBs make use of coordinated schedules. In added complexities, each group of updated network components can have different deadlines and priorities, e.g., some operation groups can have a patch that has been requested to be applied on an expedited schedule, while other groups can have the same patch applied over a longer time period.

Further, in certain embodiments, some of the processes performed can be performed by one or more specialized computers (e.g., one or more specialized processing units, a specialized computer such as tomography and reconstruction, statistical estimation, specialized routing analysis, and so on) for carrying out defined tasks related to timing the performance of change procedures for systems where system functions are implemented with different redundant safeguards. System 100 and/or components of the system can be employed to solve new problems that arise through advancements in technologies mentioned above, computer architecture, and/or the like.

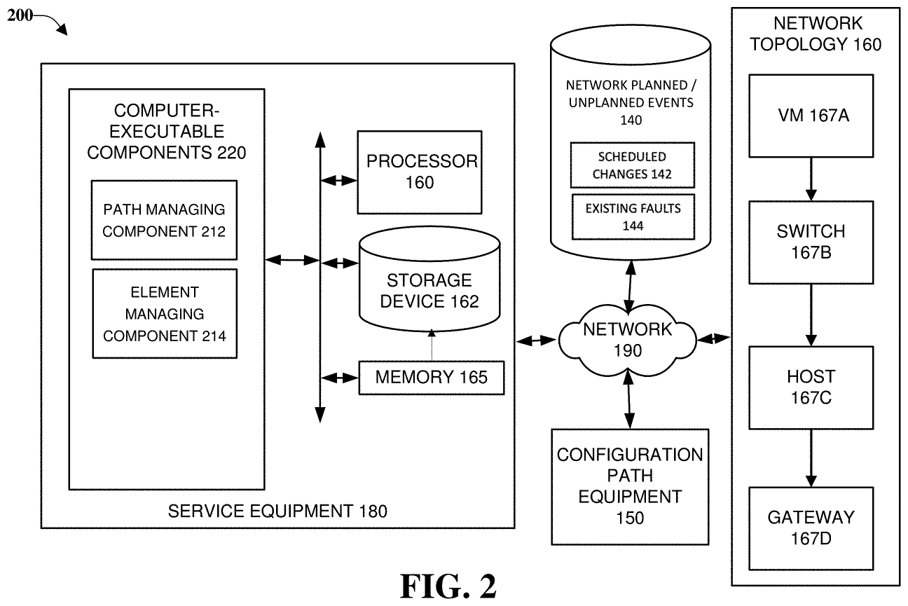

FIG. 2 is a diagram of a non-limiting example system 200 that can facilitate managing conflicts during changes to interdependent network elements, in accordance with one or more embodiments. For purposes of brevity, description of like elements and/or processes employed in other embodiments is omitted.

According to multiple embodiments, service equipment 180 can include memory 165 that can store one or more computer and/or machine readable, writable, and/or executable components and/or instructions 220 that, when respectively executed by processor 160, can facilitate performance of operations defined by the executable component(s) and/or instruction(s).

Generally, applications (e.g., computer executable components 220) can include routines, programs, components, data structures, etc., that perform particular tasks or implement particular abstract data types. In system 200, computer executable components 220 can include path managing component 212, element managing component 214, and other components described or suggested by different embodiments described herein that can improve the operation of system 200. It is noted that these components, as well as aspects of the embodiments of the subject disclosure depicted in this figure and various figures disclosed herein, are for illustration only, and as such, the architecture of such embodiments are not limited to the systems, devices, and/or components depicted therein. For example, in some embodiments, service equipment 180 can further comprise various computer and/or computing-based elements described herein with reference to operating environment 1000 and FIG. 10.

For example, in one or more embodiments, computer executable components 220 can be used in connection with implementing one or more of the systems, devices, components, and/or computer-implemented operations shown and described in connection with FIG. 2 or other figures disclosed herein. For example, in one or more embodiments, computer executable components 220 can include instructions that, when executed by processor 160, can facilitate performance of operations defining path managing component 212. In one or more embodiments, below, path managing component 212 can, in accordance with one or more embodiments, send, to configuration equipment, first path information describing a first service path of first service elements via which a service is provided.

In another example, in one or more embodiments, computer executable components 220 can include instructions that, when executed by processor 160, can facilitate performance of operations defining element managing component 214. As discussed with one or more embodiments below, element managing component 214 can, in accordance with one or more embodiments, send, to the configuration equipment, first element information describing a first service element of a group of linked service elements, wherein the first service element is comprised in the first service path. Element managing component 214 can further, in one or more embodiments, receive an indication from the configuration equipment that a first update to the first service element has been altered to be an altered update. In one or more embodiments, configuration equipment 150 can determine to alter the first update based on a second update to a second service element. In one or more embodiments, a combined group of the first service elements and second service elements can be in a second service path via which the service is provided.

In another example, in one or more embodiments, computer executable components 120 can include instructions that, when executed by processor 160, can facilitate performance of operations defining deconflicting component 126. As discussed with one or more embodiments, below deconflicting component 126 can, in accordance with one or more embodiments, determine that a conflict exists between the first update and the second update.

FIG. 3 is a diagram of a non-limiting example system 300 that can facilitate managing conflicts during changes to interdependent network elements, in accordance with one or more embodiments. For purposes of brevity, description of like elements and/or processes employed in other embodiments is omitted. As depicted, system 300 includes elements 310A-F, paths 320A-E, service paths 330A-C, and edge-devices 340A-G, in accordance with one or more embodiments. For purposes of brevity, description of like elements and/or processes employed in other embodiments is omitted.

In one or more embodiments, deconfliction reduce or eliminate impact to users/edge-devices during planned downtime activities of service-providing/infrastructure elements, while allowing multiple activities to occur simultaneously. One or more embodiments can schedule and manage change management activities across a service's horizontal and vertical service paths. In one or more embodiments, changes can be scheduled within different operation groups simultaneously. One or more embodiments can provide management deconfliction service for a software-defined wide area network (SD-WAN) service that can analyze change activities across network components that comprise the service path. One or more embodiments can identify conflicting scheduled changes that can cause service disruption with a proposed change and provides operations with scheduling options to avoid service disruption. De-confliction approaches described herein can combine the end-to-end topology of a service to be provided to edge-devices 340A-G, with open change management tickets to facilitate identifying, by an operations user, conflicting change management activities that could impact services provided to one or more customer edge nodes.

One or more embodiments can determine an end-to-end service path having a combination of virtual and physical assets, the connections between them, and the redundant service paths. When provided with a proposed change to be made during a time range to one or more parts of the end-to-end service path, one or more embodiments can utilize some or all of the end-to-end service path data to identify change conflicts that can impact customer service, and further identify time windows where the proposed change can be performed with less service impact that the initially identified time range.

As depicted in FIG. 3, one or more embodiments can facilitate identifying different aspects of system 300 that can be of interest to system administrators, e.g., elements 310A-F that are requested or required to be functioning to perform services for particular edge devices 340A-G, the impact of disabling combinations of elements 310A-F during a period of time, and other information. Thus, in an implementation, one or more embodiments identifies all elements 310A-F in paths 320A-E designated as primary and backup paths for service paths 330A-C, and combined this information with data corresponding to scheduled changes (e.g., elements 310A-F serviced over a period of time) for elements 310A-F, thereby potentially identifying conflicting changes that can impact both the primary and backup paths to service paths, resulting in impacts to service, e.g., element 310C impacting both primary path 320A and secondary path 320B for service path 330A.

One or more embodiments can provide operations including, but not limited to, post-scheduling and pre-scheduling of change activities. Pre-scheduling can be performed based on a named element or collection of elements, a start and end time window, and an estimated change duration. One or more embodiments can similarly analyze multiple primary and backup paths against open change activities to identify available time windows where a change is not likely to impact service. For example, one or more embodiments, can schedule a future change window of a given service element, using various constraints such as service paths, priority of activity etc.

FIG. 3 provides an example implementation of some embodiments in different circumstances. Among other aspects of embodiments, this example illustrates the use of an end-to-end service topology (e.g., system 300) to identify common elements that could impact one or more edge devices 340A-G. In one or more embodiments, system 300 can depict a full topology of a particular service, including all elements and systems which may touch or impact the data, in rest or transit, during normal operations and backup, or are requested or required for the operation of the systems touching the data.

With respect to system 300, vertical paths between graphic objects can define how each virtual network service is running a virtual machine that is running on a physical host. In one or more embodiments, elements 310A-F can be system components (e.g., physical or virtual) that are used for the operation of a service or function. It is noted that, in some descriptions, these components used for the operation of the service can be described as required to provide the service, with other examples described herein attributing different levels of importance to having particular elements available for provision of a particular service. As depicted, the horizontal topology defines the paths through the virtual network service elements used to provide the service along with the backup paths and redundancy specification.

As depicted in FIG. 3, paths 320A-E can be a collection one or more elements which together can provide a specific function or service, e.g., with linkage lines used in FIG. 3 to show inclusion in particular paths. In this example, an element can be a member of one or more paths, e.g., element 310A is a component that is a part of providing a service with other elements in paths 320A and 320C, shown by respective linkage lines 315A-B. Similarly, paths can share multiple elements 310A-F between them. In some circumstances, paths can include all potentially conflicted resources that are requested for provision of a specific function or service, e.g., if a system is not shared between paths, it may not be subject to the types of conflict addressed by embodiments.

In one or more embodiments, a service-path can be a collection of one or more paths, with each path providing an equivalent (or substantially equivalent to a level of similarity) service. Thus, in this example, service path 330A can provide a particular network service (e.g., a gateway service), with paths 320A-B depicted as linked by linkages 325A and 327A. In this example, to perform service a portal service, service path 330A can be selected, with alternate paths 320A-B available to perform the service, e.g., using elements 310A-C and elements 310C/E, respectively. It can be noted that element 310C is share by both paths 320A-B and thus disabling element 310C can impact the performance of service path 330A.

In some implementations, for service paths 330A-C, some of paths 320A-E can be designated as primary paths and others as secondary/backup paths, these designations being potentially set based on performance capabilities of the elements 310A-F included in the paths, a number of elements 310A-F included in the respective paths (e.g., fewer elements can indicate fewer potential points of failure), likelihood of failure, or by other differentiating factors. Thus, in this example, path 320B can be designated as a primary path for service path 330A because this path has fewer elements (e.g., elements 310C/E) than the alternate path 320A (e.g., elements 310A-C). In an alternate example, when elements 310A-C are determined to collectively have a lower likelihood of failure and/or higher performance, than elements 310C/E, path 320A can be selected as the primary path for service path 330A.

Edge devices 340A-G are depicted to illustrate consumers of the respective services provided by service paths 330A-C, e.g., linkages between provider service paths 330A-C and consumer edge devices 340A-G. Consumers of service paths 330A-C can be defined to different levels of abstraction for different applications of embodiments, e.g., ranging from individual devices, to collections of devices serving a particular customer. As depicted, linkages 342A-D show that edge-devices 340A-B, 340D, and 340F, are consumers of service path 330A

As depicted in FIG. 3, one or more embodiments can facilitate identifying different aspects of system 300 that can be of interest to system administrators, e.g., elements 310A-F that are requested or required to be functioning to perform services for particular edge devices 340A-G, the impact of disabling combinations of elements 310A-F during a period of time, and other information. Discussed below, FIG. 5 illustrates this information, and provides examples of implementations using change tickets and other forms of scheduling changes to elements 310A-F.

With respect to managing elements managed by different organizations, one or more embodiments can facilitate the coordination of element changes across the different organizations. For example, combinations of elements 310A-F can be managed by multiple organizations. By identifying which of paths 320A-E rely on the combinations of elements 310A-F, clear instructions can be generated for different organizations regarding when certain element 310A-F can be disabled for different purposes. It should be noted that, in some implementations, when a service element is disabled, it affects all paths of which it is part.

FIGS. 4 and 5 are used describe the next set of examples. FIG. 4 is a diagram of a non-limiting example system 400 that can facilitate managing changes to interdependent network elements, in accordance with one or more embodiments. FIG. 5 is a diagram of a non-limiting example 500 of timeline 510 that depicts managing changes to interdependent network elements, in accordance with one or more embodiments. For purposes of brevity, description of like elements and/or processes employed in other embodiments is omitted.

Generally speaking, one or more embodiments can perform post-checking to quickly identify any scheduled change activities that may impact service, and as well as perform pre-checking to facilitate scheduling change activities at times that won't cause conflicts. As depicted, timeline 510 includes change time period 520, and lines for three example element paths 560A-C. One or more embodiments can analyze both physical and virtual end-to-end service topologies to identify conflicts across different network layers and organizations. One or more embodiments can provide beneficial approaches to updates to single and multi-cloud environments where changes can impact not only assets of a local network, but also across different cloud environments and enterprises.

As depicted in FIG. 4, system 400 can include an SD-WAN topology with customer premises equipment (CPE) 480 having three service paths 490A-C, providing a gateway (GW) service, a service portal, and a VPN internet service gateway, respectively. As described with FIG. above, service paths (e.g., service paths 330A-C) can include separate paths of service elements (e.g., paths 320A-E). In this example, gateway service path 490A has gateway path 410A as a primary path, and gateway path 410B as a secondary, or backup path. Portal service path 490B has service portal path 440A as a primary path, and service portal path 440B a backup path. VPN internet gateway (IG) service path 490C has VPN internet service gateway paths 460A-B, in this example, operating as redundant paths, with neither designated as primary or secondary.

A different view of the type of system topology discussed with FIG. 3 is depicted in FIG. 4. To check the impact taking down an element during a given time-window, on or more embodiments can, from the topology used with system 400, identify all the paths of which this element is a member. In this example, an element PE13 420A-C is depicted as being disabled for updates or maintenance during a first period of time, labeled as change time period 520 in FIG. 5. PE13 420A-C is included in a path of all three service paths 490A-C, respectively: gateway path 410A, service portal path 440B, and VPN internet service gateway path 460A.

In an initial analysis, one or more embodiments can initially determine that this update to PE13 420A-C in the three paths does not conflict with any other updates, e.g., because during time period 520, when gateway path 410A is impacted, gateway path 410B can provide the path to gateway service path 490A, e.g., with service paths 490B-C having similar alternate paths of service elements to provide the services of the respective service paths. For this example, PE13 420A is a part of gateway path 410A, PE13 420B is a part of service portal path 440B, and VPN internet service gateway path 460A having PE13 420C. Thus, during change time period 520, the paths having 420A-C are not used, with alternate paths being used.

Continuing with this example, WAN-circuit 3 422 is sought to be updated during time period 520. In accordance with procedures described herein, different paths that include WAN-circuit 3 422 can be identified, e.g., gateway path 410A of gateway service path 490A. Even though PE 13 420A is also disabled during change time period 520, because PE13 420A is also part of gateway path 410A, and gateway path 410B is available, no conflict and no service impact is identified.

In contrast, in another example, PE7 424 can also be assessed for an update during change time period 520. Because PE7 424 and PE13 420C are in different paths 460A-B, and no alternate paths are shown, this update can be identified as potentially causing a conflict and service outage during time change time period 520. Returning to the example of FIG. 3, edge-devices 340A-G that depend from impacted VPN internet service gateway path 490C can be identified, e.g., similar to edge-devices 340A-B, 340D, and 340F being dependent on service path 330A.

In an additional example, as noted with FIG. 3 above, in some circumstances, combinations of service elements can be managed by multiple organizations, and different organizations can have different reference names for the same service elements. In a variation of the example above, either before the deconfliction process or during the deconfliction processes described above, one or more embodiments can generate a topology for analysis that uses standardized element names.

In an example based on the PE13 420A-C disabling example described above, an element of gateway path 410B (e.g., the available path after PE13 420A impacts gateway path 410A) has a topology reference name that is different from ‘PE13’, e.g., ‘provided equipment 8.’ In one or more embodiments, normalizing component 128 can utilize a normalizing reference (e.g., organizational or general) to detect an equivalence between PE, premises equipment, and provided equipment. By identifying a service element of gateway path 410B to be disabled, a potential conflict can be detected and addressed.

FIG. 5 depicts example conflicts that can be identified by one or more embodiments, e.g., at 560A, an update to PE7 424 cannot be started before, and end during the change time period 520 update of PE13 420C. In another potential conflict, the update to PE7 424 cannot, at 560B, be started during change time period 520. It is noted that, once scheduling has occurred, one or more embodiments can monitor the information described above to detect whether events have occurred that could implicate or require additional deconfliction actions.

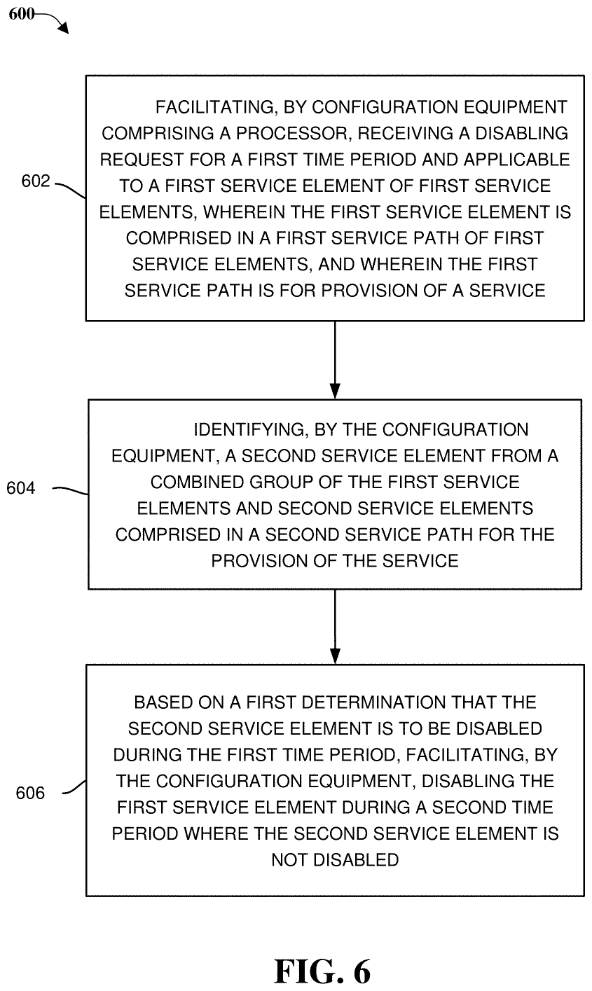

FIG. 6 illustrates an example method 600 that can facilitate managing changes to interdependent network elements, in accordance with one or more embodiments. For purposes of brevity, description of like elements and/or processes employed in other embodiments is omitted.

In one or more embodiments method 600 can include, at 602, facilitating, by configuration equipment comprising a processor, receiving a disabling request for a first time period and applicable to a first service element of first service elements, wherein the first service element is comprised in a first service path of first service elements, and wherein the first service path is for provision of a service. For example, method 600 can include facilitating, by configuration path equipment 150 comprising a processor 160, receiving a disabling request for a first time period and applicable to a first service element PE13 420C of first service elements of VPN internet service gateway path 460A, wherein the first service element is comprised in a first service path (e.g., VPN internet service gateway path 490C) of first service elements, and wherein the first service path is for provision of a service, e.g., a VPN internet gateway service.

In one or more embodiments method 600 can include, at 604, identifying, by the configuration equipment, a second service element from a combined group of the first service elements and second service elements comprised in a second service path for the provision of the service. For example, method 600 can further include identifying, by the configuration equipment, a second service element (e.g., PE7 424) from a combined group of the first service elements and second service elements comprised in a second service path for the provision of the service

In one or more embodiments method 600 can include, at 606, based on a first determination that the second service element is to be disabled during the first time period, facilitating, by the configuration equipment, disabling the first service element during a second time period where the second service element is not disabled. For example, method 600 can further include based on a first determination that the second service element is to be disabled during the first time period (e.g., change time period 520), facilitating, by the configuration equipment, disabling the first service element during a second time period 590A-B where the second service element is not disabled.

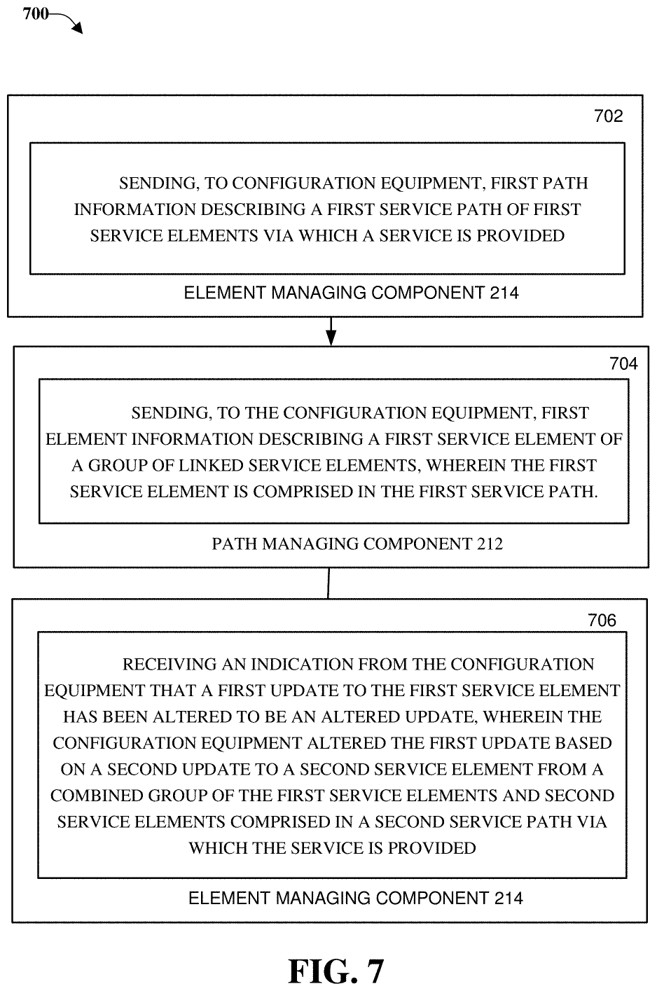

FIG. 7 is a diagram of a non-limiting example system 700 that can facilitate managing changes to interdependent network elements, in accordance with one or more embodiments. For purposes of brevity, description of like elements and/or processes employed in other embodiments is omitted. In one or more embodiments, system 700 can include a processor; and a memory that can store executable instructions that, when executed by the processor, facilitate generation of computer executable components 220, including path managing component 212 and element managing component 214. In one or more embodiments, element managing component 214 can facilitate performance of operations that can include, at 702, sending, to configuration equipment, first path information describing a first service path of first service elements via which a service is provided.

In one or more embodiments of system 700, path managing component 212 can facilitate performance of operations that can include, at 704, sending, to the configuration equipment, first element information describing a first service element of a group of linked service elements, wherein the first service element is comprised in the first service path. In system 700, in one or more embodiments, element managing component 214 can facilitate performance of operations that can include, at 706, receiving an indication from the configuration equipment that a first update to the first service element has been altered to be an altered update, wherein the configuration equipment altered the first update based on a second update to a second service element from a combined group of the first service elements and second service elements comprised in a second service path via which the service is provided.

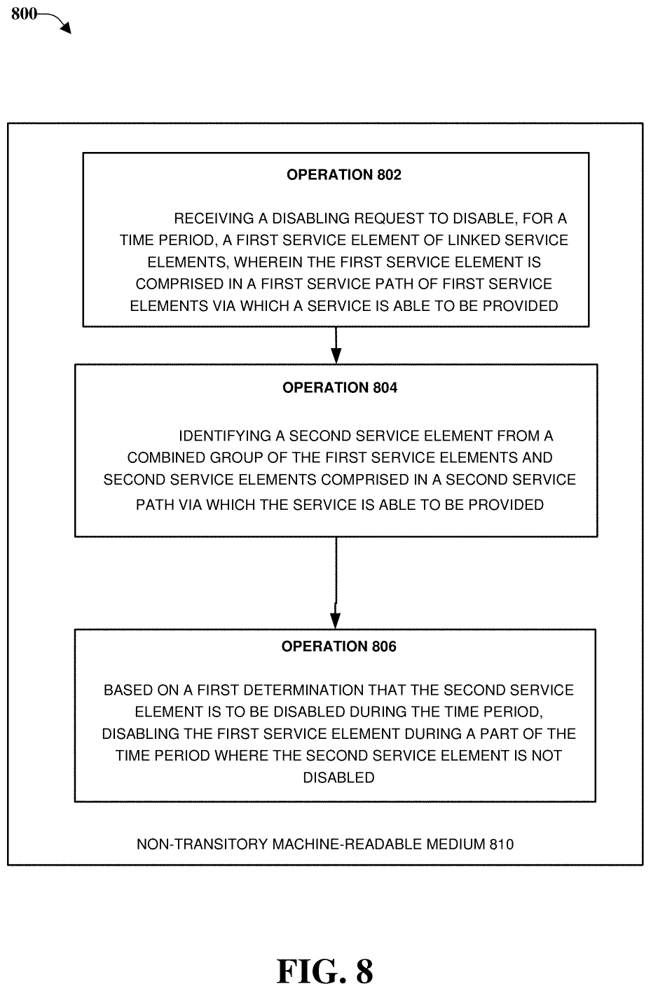

FIG. 8 depicts an example non-transitory machine-readable medium that can include executable instructions that, when executed by a processor of a system, can facilitate managing changes to interdependent network elements, in accordance with one or more embodiments described above. As depicted, non-transitory machine-readable medium 810 includes executable instructions that can facilitate performance of operations 802-806, discussed below.

In one or more embodiments, the operations can include operation 802 that receives a disabling request to disable, for a time period, a first service element of linked service elements, wherein the first service element is comprised in a first service path of first service elements via which a service is able to be provided

The operations can further include, in one or more embodiments, operation 804 that can include identifying a second service element from a combined group of the first service elements and second service elements comprised in a second service path via which the service is able to be provided.

In one or more embodiments, the operations can further include operation 806 that can include based on a first determination that the second service element is to be disabled during the time period, disabling the first service element during a part of the time period where the second service element is not disabled.

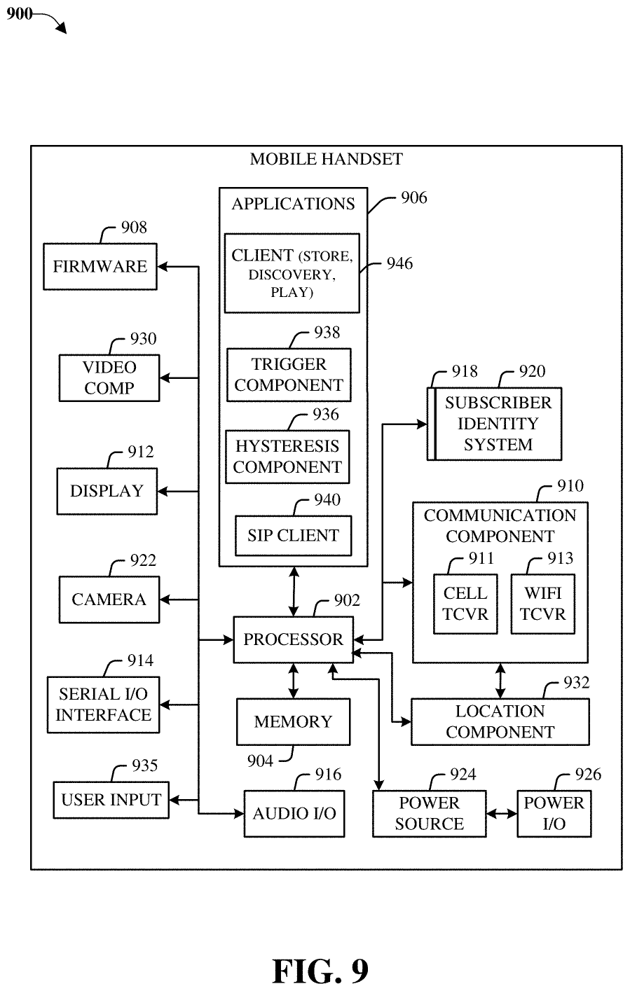

FIG. 9 illustrates an example block diagram of an example mobile handset 900 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media

The handset includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 913 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1294) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communications component 910 to accommodate IP traffic from an IP network such as, for example, the Internet, a corporate intranet, a home network, a person area network, etc., through an ISP or broadband cable provider. Thus, VoIP traffic can be utilized by the handset 900 and IP-based multimedia content can be received in either an encoded or a decoded format.

A video processing component 922 (e.g., a camera) can be provided for decoding encoded multimedia content. The video processing component 922 can aid in facilitating the generation, editing, and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 936 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 910, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

Network 190 can employ various cellular systems, technologies, and modulation schemes to facilitate wireless radio communications between devices. While example embodiments include use of 5G new radio (NR) systems, one or more embodiments discussed herein can be applicable to any radio access technology (RAT) or multi-RAT system, including where user equipments operate using multiple carriers, e.g., LTE FDD/TDD, GSM/GERAN, CDMA2000, etc. For example, wireless communication system 200 can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system 100 are particularly described wherein the devices of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the user equipment. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

Various embodiments described herein can be configured to provide and employ 5G wireless networking features and functionalities. With 5G networks that may use waveforms that split the bandwidth into several sub bands, different types of services can be accommodated in different sub bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

FIG. 10 provides additional context for various embodiments described herein, intended to provide a brief, general description of a suitable operating environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CDROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

FIG. 10 depicts an example operating environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multiprocessor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid-state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB), ROM base address (RBA), and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further to the description above, as it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine-readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipments do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It is noted that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE) or 5G; 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

While the various embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope of the various embodiments.

In addition to the various implementations described herein, it is to be understood that other similar implementations can be used, or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be affected across a plurality of devices. Accordingly, the embodiments are not to be limited to any single implementation, but rather are to be construed in breadth, spirit and scope in accordance with the appended claims.

What is claimed is:

1. A method, comprising:
facilitating, by configuration equipment comprising a processor, receiving a disabling request for a first time period and applicable to a first service element of first service elements, wherein the first service element is comprised in a first service path of first service elements, and wherein the first service path is for provision of a service; identifying, by the configuration equipment, a second service element from a combined group of the first service elements and second service elements comprised in a second service path for the provision of the service; and
based on a first determination that the second service element is to be disabled during the first time period, facilitating, by the configuration equipment, disabling the first service element during a second time period where the second service element is not disabled.

2. The method of claim 1, wherein facilitating the disabling of the first service element during the second time period is further based on a second determination that the first service element is not comprised in the second service path.

3. The method of claim 1, wherein the second time period is a portion of the first time period, and wherein the second service path was designated as an alternate service path for the first service path.

4. The method of claim 1, wherein the first service element is obtained from a virtual machine, and wherein the service comprises a virtual network function enabled via the virtual machine.

5. The method of claim 1, further comprising, based on a policy of a minimum number of service paths for the provision of the service, identifying, by the configuration equipment, a third service path for the provision of the service that does not comprise service elements that are to be disabled during the second time period.

6. The method of claim 1, further comprising:
facilitating, by the configuration equipment, receiving path information describing the first service path and the second service path from first network equipment and second network equipment, respectively; and
normalizing, by the configuration equipment, descriptive terms for the path information from the first network equipment and the second network equipment, resulting in normalized terms wherein identifying the second service element is based on the normalized terms.

7. The method of claim 6, wherein the descriptive terms are obtained from the first network equipment and the second network equipment, respectively, and wherein the first network equipment and the second network equipment are managed by different organization identities.

8. The method of claim 1, wherein the disabling request is based on a change requirement for the first service element.

9. The method of claim 1, wherein the combined group of service elements comprises virtual service elements and physical service elements.

10. First network equipment, comprising:
a processor; and
a memory that stores executable instructions that, when executed by the processor, facilitate performance of operations, comprising:
sending, to configuration equipment, first path information describing a first service path of first service elements via which a service is provided,
sending, to the configuration equipment, first element information describing a first service element of a group of linked service elements, wherein the first service element is comprised in the first service path, and
receiving an indication from the configuration equipment that a first update to the first service element has been altered to be an altered update, wherein the configuration equipment altered the first update based on a second update to a second service element from a combined group of the first service elements and second service elements comprised in a second service path via which the service is provided.

11. The first network equipment of claim 10, wherein the configuration equipment determined that a conflict existed between the first update and the second update.

12. The first network equipment of claim 11, wherein the conflict comprised a time conflict, and wherein the first update was altered to resolve the time conflict by changing an update time of the first update.

13. The first network equipment of claim 12, wherein, based on a policy of a minimum number of service paths via which the service is provided, the configuration equipment identified a third service path, via which the service is provided, that did not comprise service elements that are in conflict with the altered update.

14. The first network equipment of claim 10, wherein the second service path was tagged as an alternate service path for the first service path.

15. The first network equipment of claim 10, wherein the first service element is received from a virtual machine, and wherein the service comprises a virtual network service usable via the virtual machine.

16. A non-transitory machine-readable medium, comprising executable instructions that, when executed by a processor of a configuration system, facilitate performance of operations, comprising:
receiving a disabling request to disable, for a time period, a first service element of linked service elements, wherein the first service element is comprised in a first service path of first service elements via which a service is able to be provided;
identifying a second service element from a combined group of the first service elements and second service elements comprised in a second service path via which the service is able to be provided; and
based on a first determination that the second service element is to be disabled during the time period, disabling the first service element during a part of the time period where the second service element is not disabled.

17. The non-transitory machine-readable medium of claim 16, wherein disabling the first service element during the part of the time period is further based on a second determination that the first service element is not comprised in the second service path.

18. The non-transitory machine-readable medium of claim 16, wherein the second service path was categorized as an alternate service path for the first service path.

19. The non-transitory machine-readable medium of claim 16, wherein the first service element is able to be obtained via a virtual machine, and wherein the service comprises a virtual network service able to be performed via the virtual machine.

20. The non-transitory machine-readable medium of claim 16, wherein the operations further comprise, based on a policy of a minimum number of service paths via which the service is able to be provided, identifying a third service path, via which the service is able to be provided, that does not comprise service elements that are to be disabled during the part of the time period.
